(19) United States
(12) Patent Application Publication
(10) Pub. No.: US 2018/0290804 A1
(43) Pub. Date: Oct. 11, 2018

(54) DELIVERY DEVICE FOR BEVERAGE SUPPLEMENTS

(71) Applicant: The Nature's Bounty Co., Ronkonkoma, NY (US)

(72) Inventors: Sara Aldaous, Mineola, NY (US); Zena Sekavec, Hicksville, NY (US)

(21) Appl. No.: 15/946,771

(22) Filed: Apr. 6, 2018

Related U.S. Application Data
(60) Provisional application No. 62/482,377, filed on Apr. 6, 2017.

(51) Int. Cl. B65D 65/46; A23L 33/17; A23L 2/395; A23L 2/66

(52) U.S. Cl. CPC B65D 65/463; A23L 2/66; A23L 2/395; A23L 33/17

(57) ABSTRACT

A nutritional supplement enclosed within an edible film is claimed. The nutritional supplement and edible film form a pod that can be dissolved within a beverage. A method of manufacturing a nutritional powder supplement pod is also claimed.

### CROSS-REFERENCE TO RELATED APPLICATION

This application claims priority to U.S. Provisional Application No. 62/482,377, filed on Apr. 6, 2017, the contents of which are herein incorporated by reference in their entirety.

### BACKGROUND OF THE INVENTION

The market for nutritional supplements is one of the fastest growing industries in the United States. Currently nutritional supplements generate billions of dollars in sales, and the sales numbers are predicted to double in the next 10 years. The popularity of protein shakes and other nutritional shakes has led to an increase in the sales of various powder supplements which can be found in the nutritional aisles at specialty vitamin stores, supermarkets, drug stores, convenience stores, and general stores. These supplements are usually sold in powder form in either polyethylene terephthalate, glass, and/or high-density polyethylene large jars or stand-up resealable pouches. The consumer is provided with a pre-measured scoop and must scoop out a certain amount of powder and then mix the powder with water to form the shake. Consumers looking to take single servings of powder on-the-go are faced with the challenges of either carrying around the large jar or pouch of powder that requires disposal or somehow transporting servings of the powder in plastic bags or blender bottles.

### SUMMARY OF THE INVENTION

Applicants have found a convenient method of delivering a nutritional supplement using edible films. A nutritional supplement powder is filled into the edible film which is formed into a pod (also referred to herein as a pouch). The pod when added to any compatible liquid or beverage will dissolve with agitation or mixing.

Applicants provide a delivery device including a nutritional powder supplement enclosed within an edible film that dissolves when contacted and agitated with a beverage. Preferably, the nutritional powder supplement is protein powder. The protein powder preferably includes whey protein concentrate, instantized whey protein concentrate, non-instantized whey protein concentrate, whey protein isolate, casein, soy, soy isolate, soy concentrate, peas, rice protein, hemp protein, milk, nuts, marine protein, animal protein, collagen, bone broth, or combinations thereof.

The edible film may include polyethylene oxide (PEO), pullulan, hydroxypropylmethyl cellulose (HPMC), hydroxyethyl cellulose (HPC), hydroxypropyl cellulose, polyvinyl pyrrolidone, carboxymethyl cellulose, polyvinyl alcohol, sodium aginate, polyethylene glycol, xanthan gum, tragancanth gum, guar gum, acacia gum, arabic gum, polyacrylic acid, methylmethacrylate copolymer, carboxyvinyl copolymers, starch, modified food starch, gelatin, ethyl cellulose, hydroxypropyl ethyl cellulose, cellulose acetate phthalate, or hydroxypropyl methyl cellulose phthalate, and combinations thereof. Preferably the edible films include polyvinyl alcohol.

Preferred beverages that may dissolve the film and protein powder include water, juice, and milk.

Another aspect of the invention involves a method of manufacturing a nutritional powder supplement pod including the steps of (a) providing a nutritional powder supplement; and (b) encapsulating the nutritional powder supplement within an edible film to form a nutritional powder supplement pod, wherein the edible film dissolves upon contact and agitation with a beverage. The method of encapsulating the nutritional powder supplement may include forming a cavity in the film; filling the cavity with the nutritional powder supplement; and sealing the film. Another method of encapsulating the nutritional powder supplement may include creating a back and bottom seal with the film; filling the film with the nutritional powder supplement; and creating a top seal with the film.

### DETAILED DESCRIPTION

The present invention relates to a nutritional supplement pod enclosed within an edible, film. The nutritional supplement is an edible product which provides a health and/or medical benefit and may include food or a component of food. The nutritional supplement may be in any suitable form, preferably a gel, liquid, or powder, most preferably a nutritional powder supplement.

When the nutritional supplement is a liquid, the liquid must have incompatible properties with the film components, so that the liquid may be enclosed within the film without causing the film to dissolve or the pod to leak.

In a preferred embodiment, the invention relates to nutritional powder supplement pods containing a nutritional powder supplement enclosed within an edible film that dissolves when exposed to a compatible liquid or beverage. The pod may be added to a compatible liquid or beverage and the film and the nutritional powder supplement will dissolve with agitation to form a nutritional shake.

### Nutritional Supplements and Nutritional Powder Supplements

The nutritional supplement may be an edible supplement, food, or a component of food. Nutritional supplements are also sometimes referred to as nutraceuticals or functional foods. The edible supplement may be food and/or non-food grade.

The nutritional supplement may contain more than one “active” ingredient. An “active” ingredient would be considered any component that is biologically active in the body and provides a health and/or medical benefit. The active ingredient may already be present in the nutritional supplement or may be separately added to the nutritional supplement. Certain “active” ingredients may be marketed for immunity; muscle mass gain; joint relief; memory boosting; eye health; sleep induction; hair, skin, and nail strengthening, etc.

The nutritional supplement or nutritional powder supplement may contain one or more amino acids, vitamins, minerals, antioxidants, electrolytes, probiotics, prebiotics, or superfood extracts. A preferred supplement is protein powder. The protein may be derived from well-known sources such as whey protein concentrate, instantized whey protein concentrate, non-instantized whey protein concentrate, whey protein isolate, casein, soy, soy isolate, soy concentrate, peas, rice protein, hemp protein, milk, nuts, marine protein, animal protein such as collagen, bone broth, or combinations thereof. The protein powder may also contain fruit and/or vegetable flavorings, and performance powders such as b-Alanine, Creatine, etc. The nutritional powder supplement when mixed with a beverage may serve as a meal-replacement drink.

Vitamins that may be contained within the nutritional supplement include, but are not limited to, Multivitamins, Biotin, B-Complex, Vitamin B-12, Super B-Complex, Vitamin B-12, Vitamin B-12, Methylcobalamin, Vitamin B-2, Vitamin B-6, Vitamin C, Vitamin C Plus Zinc, Vitamin D, Vitamin D3, Vitamin E, Vitamin E Oil, Thiamin, Riboflavin, Niacin, Folic Acid, Pantothenic Acid, Keratin, Conjugated Linoleic Acid (CLA), L-Carnitine HCl, and 5-Hydroxytryptophan (5-HTP). Minerals include, but are not limited to, Alpha Lipoic Acid, Calcium, Chromium, Copper, Iodine, Iron, Magnesium, Manganese, Molybdenum, Nickel, Phosphorus, Potassium, Selenium, Silicon, Sodium, Vanadium, and Zinc. Probiotics include, but are not limited to, Lactobacillus acidophilus, Lactobacillus reuteri, B. bifidum, L. bulgaricus, and digestive enzymes. Extracts include, but are not limited to, extracts of green tea, guarana, kola nut, grapeseed, griffonia, garlic, ginger root, ginkgo, ginseng, Echinacea, evening primrose oil, black cohosh, cinnamon, cranberry, milk thistle, saw palmetto, red yeast rice, St. John's wort, turmeric, valerian root, and coconut oil. Other components of the nutritional supplement include, but are not limited to, Glucosamine, Chondroitin, Coenzyme Q-10, Melatonin, Fish Oil & Omegas, Flaxseed, Herbs, Caffeine, and other extracts.

The appropriate amount of powder to make a single serving can be readily determined by a person having ordinary skill. The single serving portion may depend upon the nutritional value of the powder and upon the type of beverage the supplement is being added to. One serving may be contained in one or more pod.

### The Edible Film

The film must be edible, i.e., safe for human consumption, and able to readily dissolve, either partially or fully, upon contact and agitation with a liquid or beverage. The film may be either food grade or non-food grade. The film must also be strong enough to hold a certain quantity of a nutritional supplement or nutritional powder supplement and maintain its integrity during packaging and transportation. The film must enclose the nutritional supplement so the nutritional supplement is portable. Preferably, the film fully encloses the nutritional supplement.

The film properties may be selected to adjust the amount of time it takes the film to dissolve or partially dissolve. For example, aspects such as the type of polymers used, the thickness of the film, and a coating over the film may be modified or employed to attain a certain time for full dissolution or partial dissolution of the pod.

The film may be made from one or more polymers. The polymer may be water soluble, water swellable, water insoluble, or a combination of one or more either water soluble, water swellable, or water insoluble polymers. The polymer may include cellulose or a cellulose derivative. Specific examples of useful water soluble polymers include, but are not limited to, polyethylene oxide (PEO), pullulan, hydroxypropylmethyl cellulose (HPMC), hydroxyethyl cellulose (HPC), hydroxypropyl cellulose, polyvinyl pyrrolidone, carboxymethyl cellulose, polyvinyl alcohol, sodium aginate, polyethylene glycol, xanthan gum, tragancanth gum, guar gum, acacia gum, arabic gum, polyacrylic acid, methylmethacrylate copolymer, carboxyvinyl copolymers, starch, modified food starch, gelatin, and combinations thereof. Specific examples of useful water insoluble polymers include, but are not limited to, ethyl cellulose, hydroxypropyl ethyl cellulose, cellulose acetate phthalate, hydroxypropyl methyl cellulose phthalate and combinations thereof.

As used herein the phrase “water soluble polymer” and variants thereof refer to a polymer that is at least partially soluble in water, and desirably fully or predominantly soluble in water, or absorbs water. Polymers that absorb water are often referred to as being water swellable polymers. The materials useful with the present invention may be water soluble or water swellable at room temperature and other temperatures, such as temperatures exceeding room temperature, for example, between 36° F. and 100° F. Moreover, the materials may be water soluble or water swellable at pressures less than atmospheric pressure. Desirably, the water soluble polymers are water soluble or water swellable having at least 20 percent by weight water uptake. Water swellable polymers having a 25 or greater percent by weight water uptake are also useful. Films or pods of the present invention formed from such water soluble polymers are desirably sufficiently water soluble to be dissolvable upon contact and agitation with a beverage.

Other polymers useful for incorporation into the films of the present invention include biodegradable polymers, copolymers, block polymers and combinations thereof. Among the known useful polymers or polymer classes which meet the above criteria are: poly(glycolic acid) (PGA), poly(lactic acid) (PLA), polydioxanoes, polyoxalates, poly(α-esters), polyanhydrides, polyacetates, polycaprolactones, poly(orthoesters), polyamino acids, polyaminocarbonates, polyurethanes, polycarbonates, polyamides, poly(alkyl cyanoacrylates), and mixtures and copolymers thereof. Additional useful polymers include, stereopolymers of L- and D-lactic acid, copolymers of bis(p-carboxyphenoxy) propane acid and sebacic acid, sebacic acid copolymers, copolymers of caprolactone, poly(lactic acid)/poly(glycolic acid)/polyethyleneglycol copolymers, copolymers of polyurethane and (poly(lactic acid), copolymers of polyurethane and poly(lactic acid), copolymers of α-amino acids, copolymers of α-amino acids and caproic acid, copolymers of α-benzyl glutamate and polyethylene glycol, copolymers of succinate and poly(glycols), polyphosphazene, polyhydroxy-alkanoates and mixtures thereof. Binary and ternary systems are contemplated.

The viscosity of the film may be adjusted. For example, to increase viscosity of the film, the polymer may be chosen of a higher molecular weight or crosslinkers may be added, such as salts of calcium, sodium and potassium. The viscosity may also be adjusted by adjusting the temperature or by adding a viscosity increasing component. Components that will increase the viscosity or stabilize the emulsion/suspension include higher molecular weight polymers and polysaccharides and gums, which include without limitation, alginate, carrageenan, hydroxypropyl methyl cellulose, locust bean gum, guar gum, xanthan gum, dextran, gum arabic, gellan gum and combinations thereof.

It has also been observed that certain polymers which when used alone would ordinarily require a plasticizer to achieve a flexible film, can be combined without a plasticizer and yet achieve flexible films. For example, HPMC and HPC when used in combination provide a flexible, strong film with the appropriate plasticity and elasticity for manufacturing and storage. No additional plasticizer or polyalcohol is needed for flexibility.

Additionally, polyethylene oxide (PEO), when used alone or in combination with a hydrophilic cellulosic polymer, achieves flexible, strong films. Additional plasticizers or polyalcohols are not needed for flexibility. Non-limiting examples of suitable cellulosic polymers for combination with PEO include HPC and HPMC.

The edible film used to make the pod may also contain a coating that is not necessarily a part of the film. For example, the coating may impart certain time release properties, etc.

Either or both an edible film or the coating of the edible film may be formulated to ensure that incidental contact with small amounts of liquid will not ruin the structural integrity of the pod, i.e., cause the pod to partially dissolve and allow some of the contents to leak out.

### Excipients

The nutritional supplement and/or edible film may contain one or more excipients that do not affect the activity of the “active” ingredient(s). Excipients may include, but are not limited to, additives as described below, diluents, binders, disintegrants, flowing agents, lubricants, and anti-caking agents.

Either or both the nutritional supplement and the edible film may contain various additives. Any additives conventionally used in nutraceuticals or pharmaceuticals can be used. For example, either or both the nutritional supplement or the film may include natural or artificial color additives, flavorings, supplements, actives, and/or sweetners. Any of the additives described below may be included to provide a desired effect. Examples of natural or artificial color additives include food, drug and cosmetic colors (FD&C), drug and cosmetic colors (D&C), or external drug and cosmetic colors (Ext. D&C). These colors are dyes, their corresponding lakes, and certain natural and derived colorants. Lakes are dyes absorbed on aluminum hydroxide.

Other examples of coloring additives include known azo dyes, organic or inorganic pigments, or coloring agents of natural origin. Inorganic pigments are preferred, such as the oxides or iron or titanium, these oxides, being added in concentrations ranging from about 0.001 to about 10%, and preferably about 0.5 to about 3%, based on the weight of all the components.

Flavors may be chosen from natural and synthetic flavoring liquids or powders. An illustrative list of such agents includes volatile oils, synthetic flavor oils, flavoring aromatics, oils, liquids, oleoresins or extracts derived from plants, leaves, flowers, fruits, stems and combinations thereof. A non-limiting representative list of examples includes mint oils, cocoa, and citrus oils such as lemon, orange, grape, lime and grapefruit and fruit essences including apple, pear, peach, grape, strawberry, raspberry, cherry, plum, pineapple, apricot or other fruit flavors.

Other useful flavorings include aldehydes and esters such as benzaldehyde (cherry, almond), citral i.e., alphacitral (lemon, lime), neral, i.e., beta-citral (lemon, lime), decanal (orange, lemon), aldehyde C-8 (citrus fruits), aldehyde C-9 (citrus fruits), aldehyde C-12 (citrus fruits), tolyl aldehyde (cherry, almond), 2,6-dimethyloctanol (green fruit), and 2-dodecenal (citrus, mandarin), combinations thereof and the like.

The flavorings may also serve as or be used in conjunction with masking agents. Masking agents are formulated to reduce or otherwise obscure off tastes that may interfere with the enjoyment and acceptability of the product. Suitable masking agents include natural and artificial sweetners, sodium sources such as sodium chloride, and hydrocolloids, such as guar gum, xanthan gum, carrageenan, gellan gum, and combinations thereof.

The sweeteners may be chosen from the following non-limiting list: glucose (corn syrup), dextrose, invert sugar, fructose, sucralose, acesulfame potassium, and combinations thereof; saccharin and its various salts such as the sodium salt; dipeptide sweeteners such as aspartame; dihydrochalcone compounds, glycyrrhizin; Stevia Rebaudiana (Stevioside); chloro derivatives of sucrose such as sucralose; sugar alcohols such as sorbitol, erythritol, mannitol, xylitol, and the like. Also contemplated are hydrogenated starch hydrolysates and the synthetic sweetener 3,6-dihydro-6-methyl-1-1-1,2,3-oxathiazin-4-one-2,2-dioxide, particularly the potassium salt (acesulfame-K), and sodium and calcium salts thereof, and natural intensive sweeteners, such as Lo Han Kuo. Other sweeteners may also be used.

Examples of flowing agents include, but are not limited to, Silicon Dioxide (SiO₂), Tri-Calcium Phosphate (TCP), Ribus Nu-Flow, or combinations thereof. The quantity of flowing agent may be determined by a person having ordinary skill in the art. For example, the SiO₂ may be present from 0.1%-1.0%, the TCP may be present from 0.1%-2.0%, and the Ribus Nu-Flow may be present from 0.1%-2.0%.

“Consisting essentially of” language would include the presence of any excipients, i.e., ingredients that do not affect the activity of the “active” ingredient(s).

### Making the Pods

The pods may be produced by various methods known in the art with standard packaging machinery such as vacuum drum machines. Specific parameters of making and filling the pods are dependent upon the characteristics of the edible film. For example, if a vacuum drum machine is being utilized, a layer of the film may be rolled out over a vacuum apparatus. The vacuum may be applied to create cavities within the film layer. The cavities are then filled with a single serving of the nutritional powder supplement to form a pocket. Another film may be deposited on top of the lower film and nutritional powder pockets and the pockets are sealed to form the pods.

Another method involves forming a cavity in the film by drawing a vacuum through a die shaped in the desired cavity; filling the cavity with the nutritional supplement; applying a top layer of film; and sealing the film to the bottom layer of film. This process describes the vacuum drum process. The alternate process involves form, fill, and seal equipment where a single roll film is utilized and the two sides are brought together to form a fin seal and then the bottom portion is sealed, the open top is filled with the nutritional supplement, and finally the open portion of the film is sealed.

The pods may be sealed by any method known in the art that will provide a seal that prevents the nutritional supplement from leaking out of the pod. The methods mentioned above, vacuum drum and form, fill, and seal, are the preferred methods of sealing the pods. In the vacuum drum forming process, the sealed film is around the perimeter of the pod. These sealed edges can be die cut to reduce the seal area. The edges can also be sealed the body of the pod, so that they do not stick out.

The pods may be manufactured to be of any shape, color, film gloss, texture, thickness of film, and size. For example, pods may be manufactured with a specific design goal in mind to differentiate its contents from that of other pods. The pods may be glossy or matte. Preferably, the thickness of the film may be 1 mm to about 4 mm. The following numbers may be arranged in any combination to create as minima, maxima, or actual values that represent the thickness of the film: 1.0 mm, 1.1 mm, 1.2 mm., 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm, 3.1 mm, 3.2 mm, 3.3 mm, 3.4 mm, 3.5 mm, 3.6 mm, 3.7 mm, 3.8 mm, and 3.9 mm and 4.0 mm.

### Using the Pods

The pods are designed to readily dissolve in a beverage of choice. The beverage may be water, milk, juice, or any other beverage that would not compromise the nutritional supplement or prevent the nutritional supplement from being absorbed into the body. Preferably, the beverage may have a water activity range (W^{a}) of 1-0.95 or a Brix range of from 0.0-60, and a preferred pH range of 2.8-9.5.

If the nutritional supplement is a protein powder, then water, juice, or milk would be the preferred liquids to dissolve the protein powder. The temperature of the beverage may also vary. For example, for protein shakes, the liquids may be room temperature, cold, or even any temperature.

The one or more pods may be added to a pre-determined amount of beverage depending upon the capacity of the pods. For example, one or two pods may be added to 6-10 fl. Oz. of liquid. The pods and liquid combination may be agitated by any means available such as shaking or stirring to dissolve the pods and the nutritional supplement in the liquid. A preferred method would involve using a shaker cup containing a metal whisk. Other methods would include using a blender or stirring in a regular cup.

Ideally, the pods will begin to dissolve within a few seconds of shaking. For example, the pods may begin to dissolve within 5 to 10 seconds of shaking. More intense shaking will accelerate the time that the film and supplement dissolve into the beverage. The temperature of the beverage may also affect the time it takes for the film and supplement to dissolve.

In this specification, groups of various parameters containing multiple members are described, e.g., types of protein powder, types of nutritional supplement, types of edible film, etc. Within a group of parameters, each member may be combined with any one or more of the other members to make additional sub-groups. For example, if the members of a group are a, b, c, d, and e, additional sub-groups specifically contemplated include any two, three, or four of the members, e.g., a and c; a, d, and e; b, c, d, and e; etc.

In some cases, the members of a first group of parameters, e.g., a, b, c, d, and e, may be combined with the members of a second group of parameters, e.g., A, B, C, D, and E. Any member of the first group or of a sub-group thereof may be combined with any member of the second group or of a sub-group thereof to form additional groups, i.e., b with C; a and c with B, D, and E, etc.

With each group, it is specifically contemplated that any one of more members can be excluded. For example, various polymers are included in the list of edible films. One or more polymers may be excluded from the list to form a shorter list of edible films.

A list following the word “comprising” is inclusive or open-ended, i.e., the list may or may not include additional unrecited elements. A list following the words “consisting of” is exclusive or closed ended, i.e., the list excludes any element not specified in the list.

### EXAMPLES

### Example 1

Body Fortress® Advanced Whey Protein Vanilla Flavor, Body Fortress® Advanced Whey Protein Strawberry Flavor, Whey Protein Chocolate Flavor and Body Fortress® NOS Blast Fruit Punch Performance Powder were encapsulated within an edible film that is soluble in water (36° F.-70° F.). The ingredients of the film were hydroxypropyl methyl cellulose, propylene glycol, citric acid, and modified food starch. Square and rectangular shaped pods were made from the film and then filled with a single serving of (10 g-50 g) Advanced Whey or 12 g NOS Blast performance powder.

The samples were prepared on a bench scale. The edible film was rolled out and sealed with a hand-held sealer. A back seal was created then a bottom seal. The pouch was filled and then a top seal was formed.

### Example 2

The pods prepared in Example 1 were tested to determine their ability to dissolve in a beverage. 8-10 fl. oz. of bottled spring water at various temperatures: room temperate (67° F.-70° F.) and chilled (36° F.-38° F.) was poured into a shaker bottle containing a wire ball or metal ball whisk. One protein pod was deposited within each bottle.

The bottles were rigorously shaken. Within 5-10 seconds of shaking, the film dissolved exposing the protein powder and changing the color of the water. Within 30 seconds of shaking, the protein powder was completely dissolved.

1. A delivery device comprising a nutritional powder supplement enclosed within an edible film that dissolves when contacted with a beverage.

2. The delivery device of claim 1, wherein the nutritional powder supplement is protein powder.

3. The delivery device of claim 2, wherein the protein powder comprises whey protein concentrate, instantized whey protein concentrate, non-instantized whey protein concentrate, whey protein isolate, casein, soy, soy isolate, soy concentrate, peas, rice protein, hemp protein, milk, nuts, marine protein, animal protein, collagen, bone broth, or combinations thereof.

4. The delivery device of claim 1, wherein the edible film comprises polyethylene oxide (PEO), pullulan, hydroxypropylmethyl cellulose (HPMC), hydroxyethyl cellulose (HPC), hydroxypropyl cellulose, polyvinyl pyrrolidone, carboxymethyl cellulose, polyvinyl alcohol, sodium aginate, polyethylene glycol, xanthan gum, tragancanth gum, guar gum, acacia gum, arabic gum, polyacrylic acid, methylmethacrylate copolymer, carboxyvinyl copolymers, starch, modified food starch, gelatin, ethyl cellulose, hydroxypropyl ethyl cellulose, cellulose acetate phthalate, or hydroxypropyl methyl cellulose phthalate, and combinations thereof.

5. The delivery device of claim 4, wherein the edible film comprises polyvinyl alcohol.

6. The delivery device of claim 1, wherein the beverage is water, juice, or milk.

7. The delivery device of claim 1, wherein the nutritional powder supplement comprises a flowing agent.

8. A method of manufacturing a nutritional powder supplement pod comprising:
(a) providing a nutritional powder supplement; and
(b) encapsulating the nutritional powder supplement within an edible film to form a nutritional powder supplement pod, wherein the edible film dissolves upon contact with a beverage.

9. The method of claim 8, wherein encapsulating the nutritional powder supplement comprises forming a cavity using the film; filling the cavity with the nutritional powder supplement; and applying a top layer of film to seal the cavity.

10. The method of claim 9, wherein the cavity is formed using a vacuum drum machine.

11. The method of claim 10, wherein the nutritional powder supplement is protein powder.

12. The method of claim 11, wherein the protein powder comprises whey protein concentrate, instantized whey protein concentrate, non-instantized whey protein concentrate, whey protein isolate, casein, soy, soy isolate, soy concentrate, peas, rice protein, hemp protein, milk, nuts, marine protein, animal protein, collagen, bone broth, or combinations thereof.

13. The method of claim 8, wherein the edible film comprises polyethylene oxide (PEO), pullulan, hydroxypropylmethyl cellulose (HPMC), hydroxyethyl cellulose (HPC), hydroxypropyl cellulose, polyvinyl pyrrolidone, carboxymethyl cellulose, polyvinyl alcohol, sodium aginate, polyethylene glycol, xanthan gum, tragancanth gum, guar gum, acacia gum, arabic gum, polyacrylic acid, methylmethacrylate copolymer, carboxyvinyl copolymers, starch, modified food starch, gelatin, ethyl cellulose, hydroxypropyl ethyl cellulose, cellulose acetate phthalate, or hydroxypropyl methyl cellulose phthalate, and combinations thereof.

14. The method of claim 13, wherein the edible film comprises polyvinyl alcohol.

15. The method of claim 8, wherein the nutritional powder supplement comprises a flowing agent.

16. The method of claim 8, wherein the beverage is water, juice, or milk.

17. The method of claim 8, wherein encapsulating the nutritional powder supplement comprises creating a back and bottom seal with the film; filling the film with the nutritional powder supplement; and creating a top seal with the film.
